(19) United States
(12) Patent Application Publication
(10) Pub. No.: US 2011/0189980 A1
(43) Pub. Date: Aug. 4, 2011

(54) METHOD OF SENDING INFORMATION

(75) Inventors: David René Proulx, Waterloo (CA); Sherryl Lee Lorraine Scott, Waterloo (CA); Matthew Bells, Waterloo (CA); Alek Tziortzis, Rolling Meadows, IL (US)

(73) Assignee: RESEARCH IN MOTION LIMITED, Waterloo (CA)

(21) Appl. No.: 12/700,463

(22) Filed: Feb. 4, 2010

(51) Int. Cl. H04W 4/00

(52) U.S. Cl. 455/414.1

(57) ABSTRACT

A device stores one or more media and metadata related to those media. The media and/or the metadata is sent by the device and an information server receives the media and/or metadata. The information server may store additional metadata related to the media and/or metadata. The information server sends information, e.g., an advertisement, and the wireless portable communication device 100 receives the information/advertisement that is related to the media and/or metadata.

### TECHNICAL FIELD

The present disclosure relates generally to a wireless portable communication device providing metadata and/or media to a network and receiving information based on the metadata and/or media.

### BACKGROUND OF THE DISCLOSURE

Wireless portable communication devices are popular for business and personal use. Such devices include Personal Digital Assistants (PDAs), cellular phones and smart phones. These devices provide wireless two-way voice and data communication over wireless networks such as GSM/GPRS, CDPD, TDMA, iDEN Mobitex, DataTAC, EDGE or UMTS networks, and broadband networks like Bluetooth® wireless technology developed by Bluetooth SIG, Inc., Bellevue, Wash., U.S.A. and variants of IEEE standard 802.11.

Information servers, including advertisement servers, provide information to devices such as the wireless portable communication devices described above. The information provided includes content that may be in the form of text, images, videos, audio recordings, links to other content, and so forth. Advertisement servers may provide ads that are not appropriate to for each device.

It is desirable to send appropriate information to wireless portable communication devices.

### BRIEF DESCRIPTION OF THE DRAWINGS

FIG. 1 is a block diagram of a wireless portable communication device in accordance with at least one of the embodiments in the present disclosure;

FIG. 2 is a block diagram of a server in accordance with at least one of the embodiments in the present disclosure;

FIG. 3 is a block diagram illustrating the communication links between a server and multiple devices in accordance with at least one of the embodiments in the present disclosure;

FIG. 4A and FIG. 4B are flow charts illustrating a method of a wireless portable communication device for receiving information in accordance with at least one of the embodiments in the present disclosure;

FIG. 5A and FIG. 5B are flow charts illustrating a method of a server for sending information in accordance with at least one of the embodiments in the present disclosure;

FIG. 6 is a data flow diagram for communicating information between a wireless portable communication device and a server in accordance with at least one of the embodiments in the present disclosure.

### DETAILED DESCRIPTION

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description does not limit the scope of the embodiments described herein.

Information servers that distribute information, which may include advertisements, to wireless portable communication devices may distribute information that is not appropriate to for each of the wireless portable communication devices. To mitigate the possibility of sending information that is not appropriate, wireless portable communication devices send media or metadata to the information server. The information server analyzes the media or metadata and determines what information is more appropriate for individual wireless portable communication devices based on the media or metadata. In so doing, the information sent by the information server to the wireless portable communication device is more appropriate.

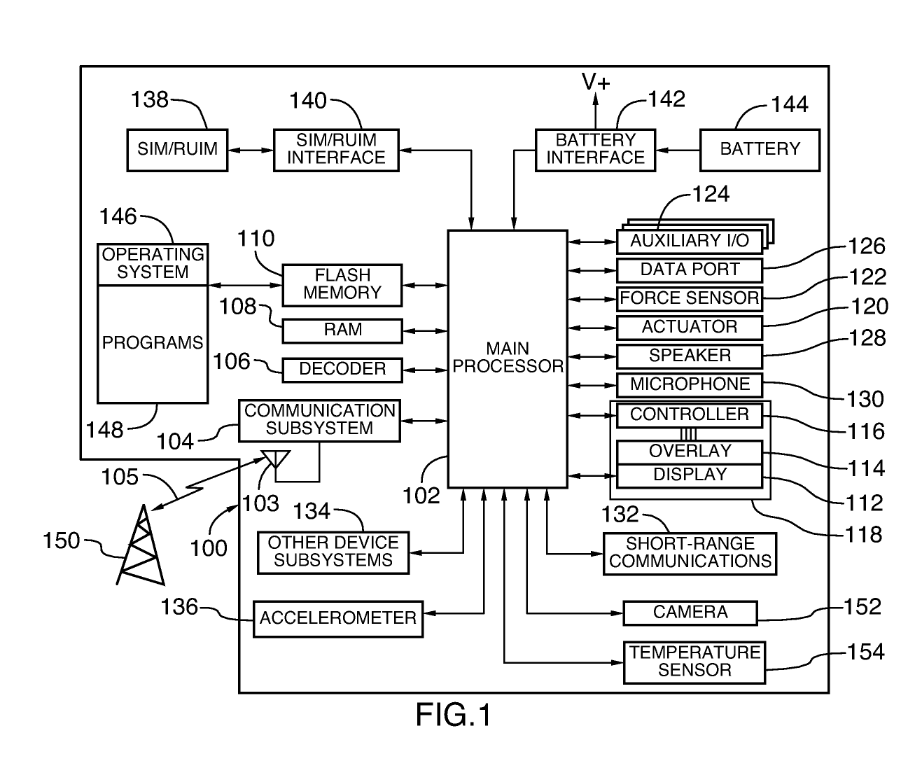

FIG. 1 illustrates a wireless portable communication device 100 that has a number of components, including a processor 102 that controls the overall operation of the wireless portable communication device. Communication functions, including data and voice communications, are performed through a communication subsystem 104 that includes a radio frequency transceiver connected to an antenna 103. Data received by the wireless portable communication device 100 is decompressed and decrypted by a decoder 106. The communication subsystem 104 and an antenna 103 receive messages from and send messages to a wireless network 150 via signals 105. The wireless network may be, but not limited to, data-centric wireless networks, voice-centric wireless networks, and dual-mode networks that support both voice and data communications. The wireless portable communication device 100 includes a battery interface 142 for receiving one or more rechargeable batteries 144.

The processor 102 also interacts with additional components such as a random access memory (RAM) 108, a flash memory 110, a display 112. The display 112 may be a touch screen, which includes a touch sensitive overlay 114 connected to an electronic controller 116 that together make up a touch sensitive display 118. The touch sensitive display 118 may be coupled to an actuator 120 and a force sensor 122 to receive inputs. The wireless portable communication device 100 may further include an auxiliary input/output (I/O) subsystem 124, a data port 126, a speaker 128, a microphone 130, temperature sensor 154, camera 152, accelerometer 136, a Subscriber Identity Module or a Removable User Identity Module (SIM/RUIM) card 138 inserted into a SIM/RUIM interface 140 for communication with the wireless network 150, short-range communications subsystem 132 and other device subsystems 134. The processor 102 interacts with the touch-sensitive overlay 114 via the electronic controller 116.

The wireless portable communication device 100 also includes an operating system 146 and software components 148 that are executed by the processor 102 and are typically stored in a persistent store such as the flash memory 110. Additional applications may be loaded onto the wireless portable communication device 100 from the wireless network 150, the auxiliary I/O subsystem 124, the data port 126, the short-range communications subsystem 132, or any other suitable device subsystem 134.

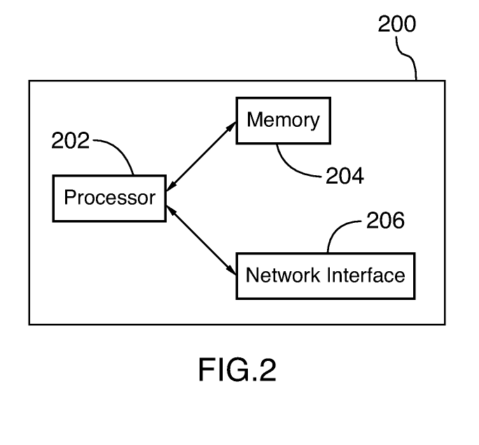

FIG. 2 is a block diagram of a server in accordance with the present disclosure. An information server 200 comprises a processor 202, memory 204, and network interface 206. The information server 200 may be a part of a mainframe, computer farm, or cloud of computers and have access to substantially more processing power and resources than wireless portable communication devices. Via processor 202, the information server 200 stores information, which may be in the form of one or more advertisements or ads, in the memory 204 and sends the information via network interface 206.

The processor 202 is configured to perform the programming instructions stored on the memory 204 to perform the operations of the information server 200. Although it is illustrated as a single processor, the information server 200 may comprise multiple physical, logical, or virtual processors that may themselves comprise one or more cores.

The memory 204 comprises a computer readable medium and allows for the storage of data and programming instructions used by the processor 202. Although it is illustrated as a single memory, the information server 200 may comprise multiple physical, logical, or virtual memories, forms of which may include any combination of: random access memory (RAM), flash memory, magnetic storage, optical storage, and so forth.

The network interface 206 allows for the information server 200 to communicate with other devices outside of the information server 200. Although it is illustrated as a single network interface, the information server 200 may comprise multiple network interfaces that provide for communication over one or more types of wired or wireless networks.

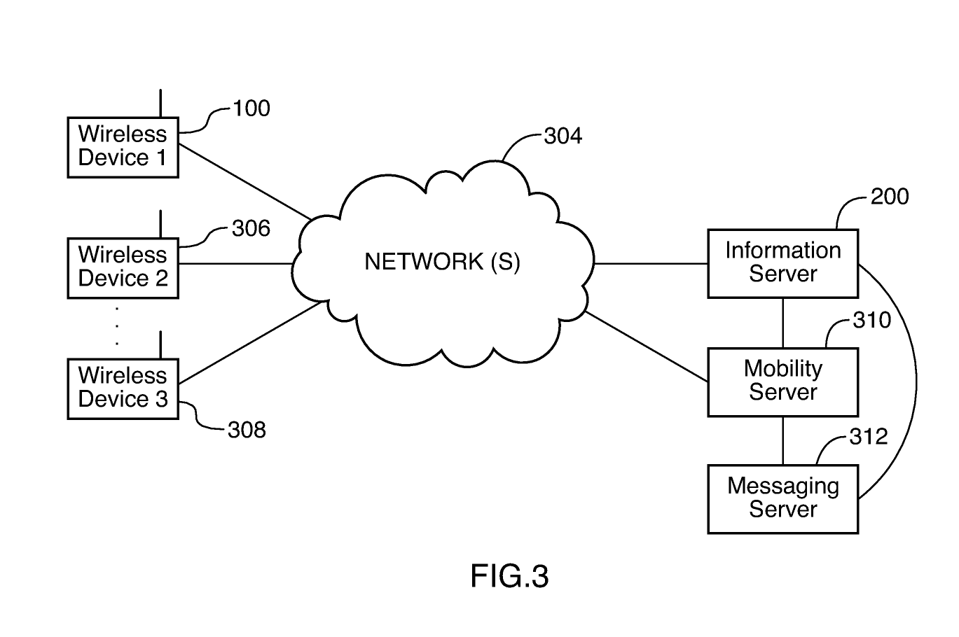

FIG. 3 is a block diagram illustrating the communication links between a server and multiple devices in accordance with at least one of the embodiments in the present disclosure. The information server 200 is communicatively connected via one or more networks 304 to the devices 100, 306, and 308. The information server 200 is also communicatively connected to a mobility server 310 and a messaging server 312. The mobility server 310 may also be connected to the messaging server 312. To increase the pertinence and/or appropriateness of the information sent from the information server 200 to the devices 100, 306, and 308, the information may be based at least in part on data (e.g., media) and/or metadata that the information server 200 receives from the mobility server 310, the messaging server 312, and/or the devices 100, 306, and 308.

As an example, a user of a device may be shopping for a car and visiting multiple car dealerships, taking pictures of the cars in which the user is interested. In this case, the device may send a picture of a first car at a first dealership at a first GPS location to the server and subsequently send a second picture of a second car at a second dealership at a second GPS location to the server. From the received information, the server may determine that the user of the device is shopping for cars and the server may then send an advertisement comprising an offer for a similar car at a third dealership. In this way, the information/advertisement will be pertinent and appropriate and have a higher likelihood of being consumed or followed with by the user of the device.

The metadata may also indicate other various factors relevant to the user of the device. As an example, when the metadata indicates the temperature is below freezing, an advertisement for ice cream may be less appropriate than an advertisement for hot chocolate. As another example, when the metadata indicates the wireless portable communication device 100 is located at corner of a street intersection, an advertisement for a motorcycle helmet may be less pertinent than an advertisement for taxi cab services. As such, when the information is an advertisement, the advertisement will have a higher likelihood of being successful. In other words, there is a higher chance that the advertisement will be consumed.

The mobility server 310 provides mobility services that, among other things, provide for synchronization of email, calendar, and address book information between the messaging server 312 and the devices 100, 306, and 308. The mobility server 310 may also provide information related to interne browsing by the devices 100, 306, and 308.

The messaging server 312 provides messaging services that, among other things, provide for the sending and receiving of messages, the storage of calendar information, and the storage of address book information. The messaging services provided by the messaging server 312 may be in the form of email, instant messaging, video conferencing, voice mail, text messaging, picture messaging, and so forth.

The networks 304 provide for communicatively connecting the information server 200 to the devices 100, 306, and 308, to the mobility server 310, and to the messaging server 312 (not shown). The networks 304 may also communicatively connect the mobility server 310 to the devices 100, 306, and 308 and communicatively connect the messaging server 312 to the devices 100, 306, and 308 (not shown). The networks 304 may be in the form of one or more wired or wireless networks that accord with various standards including Bluetooth, Wi-Fi, 3GPP, LTE, GSM, Ethernet, and so forth.

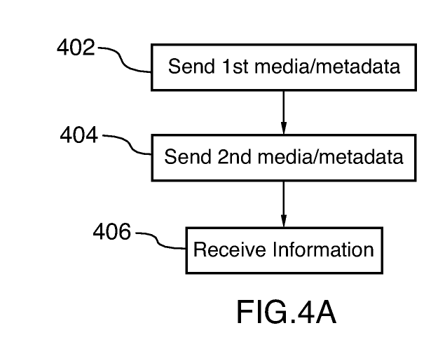

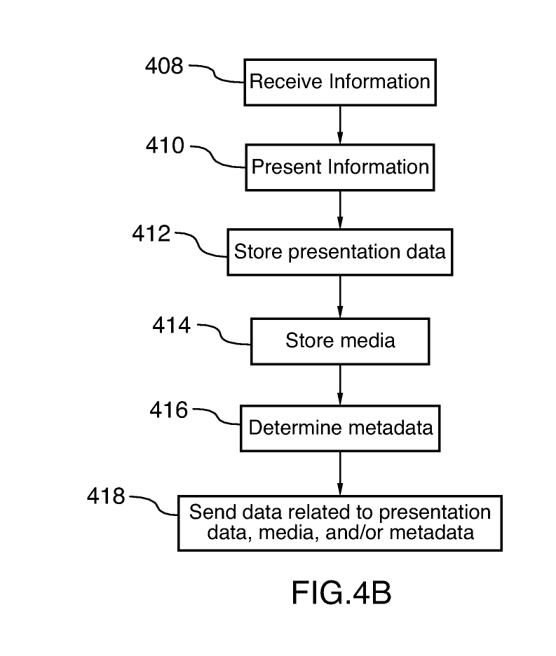

FIG. 4A is a flow chart illustrating a method of a wireless portable communication device wireless portable communication device 100, for receiving information in accordance with at least one of the embodiments in the present disclosure. After sending multiple sets of media and/or metadata, the wireless portable communication device 100 receives targeted information that is related to the multiple sets of media and/or metadata. By relating the information to the plurality of media, the information has a higher likelihood of being relevant, pertinent, and appropriate to the wireless portable communication device 100.

The wireless portable communication device 100 sends at least one of a first media and a first metadata at 402. The media may include any data that is captured by or downloaded to the wireless portable communication device 100 and may be any of an image, a video recording, an audio recording, and so forth. The media and/or metadata may be stored to temporary or permanent storage, such as to random access memory (RAM) 108 or to flash memory 110. As an example, an image captured by the camera 152 may be considered to be stored when it is cached in RAM 108 even when the image is not stored in the flash memory 110 or other permanent memory of the wireless portable communication device 100.

The metadata may include any data from any one or combination of different sources, including: temperature data from the temperature sensor 154; location data related to global positioning system (GPS) data; orientation data from the accelerometer 136; application data from the software components 148, which may include presence or other social networking data, calendar data, address book data, email data, and instant messaging data; power data related to the battery power status or battery charge level of the battery 144; network status data related to the providers, types, and signal strengths of network coverage; analysis data related to the persons, places or things recorded in the media; a compressed version of the media; notification data related to any notifications on the wireless portable communication device 100; and so forth. The metadata may also comprise: explicit preferences, such as “I like ice cream”; behaviorally inferred preferences, such as the wireless portable communication device detects its location to be inside of and ice cream store on numerous occasions; and externally inferred preferences, such as the device detects that it's 5:00 PM and the temperature is warm so that information about or an advertisement for ice cream would be pertinent and appropriate.

Additionally, the sending of the media and/or metadata may be in response to the capturing of the media by the wireless portable communication device 100. For example, when the wireless portable communication device 100 is a camera phone, the wireless portable communication device 100 may send the media and/or metadata after each picture taken by the camera is stored. When the wireless portable communication device 100 sends media and not metadata, a server that receives the media can generate the metadata.

The wireless portable communication device 100 sends at least one of the second media and the second metadata at 412. The second media may be of the same or different type from the first media. For example, the first media may be a picture taken with camera 152, and the second media may be a sound recording taken via microphone 130.

As described above, the metadata may include data from any one or combination of different sources. The second metadata may also include differential or delta data/metadata that is related to the differences between any combination of one or more of the first media, first metadata, second media, and second metadata. For example, the second metadata may be related to a change in temperature from when the first media is stored to when the second media is stored, which may indicate the that the wireless portable communication device 100 is now outdoors instead of indoors so that information more appropriate for an outdoors environment may be sent by the information server 200 and received by the wireless portable communication device 100.

The first metadata and second metadata may also include further derived metadata. As an example, the metadata may include the time of day when photos are taken, from which it is further derived that photos are generally taken during specific times of day. Given this further derived metadata as a party of the metadata sent to the information server 200, specific information or ads may be targeted to the wireless portable communication device 100. As such, the derived metadata may indicate that photos are taken between the hours of 7 and 9 in the morning, and the information server 200 may send ads relating to breakfast foods purchasable near the location of the wireless portable communication device 100. The further derived metadata may also include: an average temperature; a relation between the temperature and the time of day; or other weather conditions such as humidity, sunlight, pressure and so forth.

Additionally, embodiments may have the wireless portable communication device 100 only sending media, only sending metadata, or any combination of media and metadata. As such, there may be three options for the first set of media and/or metadata that is sent—only media, only metadata, and a combination of media and metadata—and there may be four options for the second set of media and/or metadata—no media and no metadata, only media, only metadata, and a combination of media and metadata—so that there may be at least twelve possibilities for what media and/or metadata are sent.

Alternative embodiments may consolidate a plurality of media and/or metadata that is to be sent into one message. For example, a wireless portable communication device 100 may consolidate a plurality of media and/or metadata for a fixed period of time, e.g., 24 hours, and send the plurality of media and/or metadata at a fixed time to the information server 200, e.g., during off-peak hours, so as to save on data transfer charges. As another example, the wireless portable communication device 100 may send a consolidated plurality of media and/or metadata when a particular network connection becomes available. For instance, it may be less expensive to transfer data over a Wi-Fi network as compared to a 3G network, so that a wireless portable communication device 100 may be configured to send the media and/or metadata via the Wi-Fi network instead of the 3G network.

Additionally, whether the wireless portable communication device 100 sends media, metadata, or both may be based on differences between current media and/or metadata and formerly sent media. When a first media and/or metadata is substantially the same as a second media and/or metadata, the device may send the first media and/or metadata but not send the second media and/or metadata. For example, when a second picture stored by the wireless portable communication device 100 is substantially similar to a first picture stored by the wireless portable communication device 100, the second picture may not be sent while the metadata related to the second picture is sent. In alternate embodiments, when a second metadata related to a second media is substantially similar to a first metadata related to a first media, the second picture may not be sent while the metadata related to the second picture may be sent. Furthermore, when there are differences between the first and second metadata, the differences between the first and second metadata may be sent in lieu of the entire first and second metadata so as to conserve the amount of data being transmitted between the wireless portable communication device 100 and the information server 200.

FIG. 4B is a flowchart illustrating a method of a wireless portable communication device 100, for receiving information in accordance with at least one of the embodiments of the present disclosure. After receiving information based at least in part on multiple sets of media and/or metadata, the wireless portable communication device 100 presents the information, stores presentation data related to the presentation of the information, stores additional media and/or metadata, and sends data related to the presentation data, media, and/or metadata. By sending data relating the presentation of the information, the information has a higher likelihood of being relevant, pertinent, and appropriate to the wireless portable communication device 100.

The wireless portable communication device 100 receives information at 408. The information may be in the form of any one or combination of text, images, video, audio, and so forth. The information may also be an indicator, identifier, or link that indicates, identifies, or links to a location of the text, images, video, audio, and so forth. For example, information server 200 may send information in the form of a message that the wireless portable communication device 100 receives, wherein the message comprises an indicator in the form of an offset identifying where in the message the text, images, video, audio, and so forth are located. The information that is sent is based on any one or combination of the first media, second media, first metadata, and second metadata. As such, the information is related to the first media and second media and is more pertinent and/or appropriate.

The wireless portable communication device 100 presents the information at 410. For example, text, images, and video may be shown on display 112 and/or audio may be played via speaker 128. The wireless portable communication device 100 may present the information as soon as the information is received, or the wireless portable communication device 100 may store the information for later presentation. For example, when an image capture or camera program is the active program when the information is received, the information may be presented as a banner advertisement on a part of the camera program's viewable area. As an alternative example, the information may be stored and presented later when a game application becomes the active program.

Additionally, the presentation of the information may be limited by various settings or preferences stored on the wireless portable communication device 100. For example, the wireless portable communication device 100 may comprise preferences that only allow images to be presented from the information received, but that no video or audio may be presented from the information.

The wireless portable communication device 100 stores presentation data at 412. The presentation data relates to the presentation of the information and may include data related to any one or combination of: what application presented the information, the duration of the presentation of the information, requests related to the information, and so forth. In one embodiment, presentation data may include that a request for more content related to the information is sent subsequent to when the information is displayed. For example, the information may be displayed as an advertisement on a webpage that when accessed or clicked on generates a request for more content related to the advertisement.

The wireless portable communication device 100 optionally stores additional media at 414. The additional media may be captured by the wireless portable communication device 100 subsequent to any one or more of: receiving the information, presenting the information, and/or storing presentation data.

The wireless portable communication device 100 optionally determines additional metadata at 416. The additional metadata may be stored by the wireless portable communication device 100 subsequent to any one or more of: receiving the information, presenting the information, and/or storing presentation data. Additionally, the additional metadata may indicate a relation between the additional media to the information that was received at 408.

The wireless portable communication device 100 sends data related to the presentation data, the additional media, and/or the additional metadata at 418. The data may be sent in conjunction with the storage of the presentation data. Alternatively, the data may be sent with a subsequent set of media/metadata. The presentation data may include data related to any one or combination of: what application presented the information, the duration of the presentation of the information, requests related to the information, and so forth. In one embodiment, presentation data may include that a device sent a request for more content related to the information subsequent to when the device displays the information. For example, the information may be displayed as an advertisement on a webpage that when accessed, clicked on, or consumed generates a request for more content related to the advertisement.

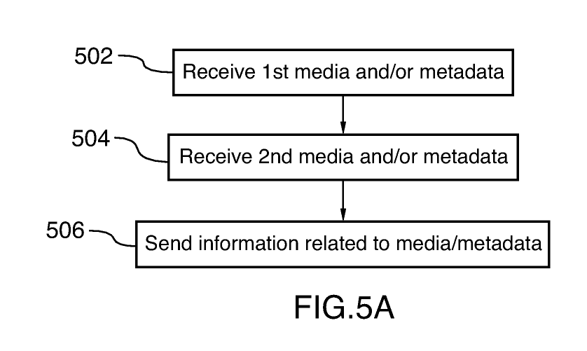

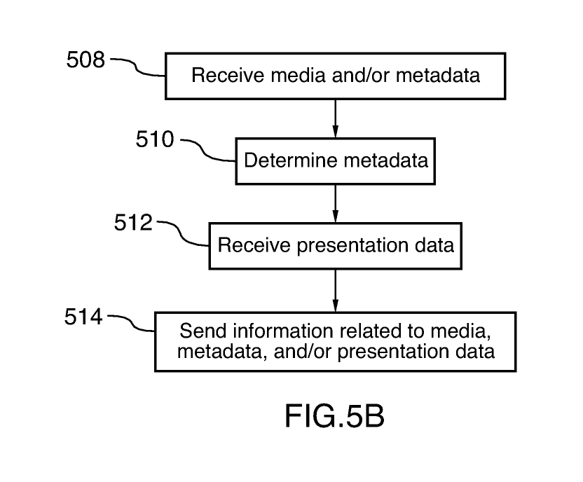

FIG. 5A is a flowchart illustrating a method of a server, such as information server 200, for sending information in accordance with at least one of the embodiments in the present disclosure. The information sent, such as an advertisement or ad, from the information server 200 to the wireless portable communication device 100, is related to the plurality of media captured or stored by the wireless portable communication device 100 and received by the information server 200. By relating the information to the plurality of media, the information has a higher likelihood of being relevant, pertinent, and appropriate to the wireless portable communication device 100.

At 502, the information server 200 receives the first media and/or first metadata from one of a plurality of devices. The information server 200 may store the first media and/or metadata for the plurality of devices in one or more databases. For example, all of the media and/or metadata received may be stored in a single database that includes identifiers for which devices sent the data or metadata, or, alternatively, the information server may store the media and/or metadata in individual databases for each of the devices sending the data. Additionally, the media and/or metadata may be deleted after a period of time. For example, media that is more than three days old may no longer be relevant to a determination of what ads are appropriate for a device.

The information server 200 receives the second media and/or second metadata from one of a plurality of devices at 504. The first media and/or metadata may be received by the information server 200 in a first message and the second media and/or metadata may be received by the information server 200 in a second message. Alternatively, a plurality of media and/or metadata may be received by the information server in a single message sent by one of the plurality of devices.

The information server 200 then sends information, such as an advertisement, at 506. As discussed above, the information may include any one or combination of text, images, video, audio, identifiers, indicators, links, and so forth. The information sent is based on any one or combination of the media and metadata. As such, the information sent is related to the media and is more pertinent and/or appropriate.

Additionally, the information server 200 may send the information as soon as the information server 200 has enough media/metadata on which to base the information. In other words, the information server 200 may send the information after enough of a plurality of media/metadata is received from individual devices to determine a type and/or content of the information that would be most appropriate for each of the individual devices. Hence, the information server 200 may not send the information until after receiving the second media and/or metadata or after subsequent media and/or metadata are sent.

Additionally, the information server 200 may send the information when the wireless portable communication device 100 requests other forms of content. For example, the information server 200 may send the information when the wireless portable communication device 100 requests an Internet webpage so that in effect, the information server 200 is injecting the information into the content requested by the wireless portable communication device 100.

FIG. 5B is a flowchart illustrating a method of a server, such as information server 200, for sending information in accordance with at least one of the embodiments in the present disclosure. The information server 200 receives media and/or metadata from a plurality of devices, optionally determines additional metadata related to the received media/metadata, receives presentation data, and sends information related at least in part to at least one of the media, metadata, and/or presentation data.

At 508, the information server 200 receives media and/or metadata from a plurality of devices. As discussed above, the information server 200 may store the media and/or metadata for the plurality of devices in one or more databases. The media and/or metadata may be received by the information server 200 via individual messages. Alternatively, a plurality of media and/or metadata from on of the plurality of devices may be received by the information server in a single message that consolidates multiple sets of media/metadata into a single message.

At 510, the information server 200 optionally determines additional metadata related to the media/metadata received at 508. As such, metadata related to the media may be generated or determined by the wireless portable communication device 100, e.g., first metadata, and the metadata related to the media may be generated or determined by the information server 200, e.g., third metadata. With access to more powerful resources, the information server 200 may perform a more intensive analysis of the media and/or metadata. This more intensive analysis may include any form of image recognition, such as text recognition, facial recognition, and so forth. For instance, the intensive analysis may determine the make and model of a car in a picture captured by the wireless portable communication device 100. Additionally, further inferences may be derived from the intensive analysis. For example, a media may comprise an image of a street sign from which a street name is recognized and the location of a point of interest can be inferred.

The metadata may also include differential or delta data/metadata that is related to the differences between any combination of the media/metadata received from individual devices. For example, a picture taken at a first car dealership having a first set of GPS coordinates may be compared to the GPS coordinates related to a second picture to infer how far the user of the device is willing to travel to shop for cars.

At 512, the information server 200 receives presentation data. The presentation data relates to the presentation of information previously sent to any of the plurality of devices. The presentation data may include data related to any one or combination of: what application presented the information, the duration of the presentation of the information, requests related to the information, and so forth. In one embodiment, presentation data may include that a device sent a request for more content related to the information subsequent to when the device displays the information. For example, the information may be displayed as an advertisement on a webpage that when accessed or clicked on generates a request for more content related to the advertisement.

At 514, the information server 200 sends information, such as an advertisement. As discussed above, the information may include any one or combination of text, images, video, audio, identifiers, indicators, links, and so forth.

The information sent is related at least in part to any one or combination of the media, metadata, and presentation data received from the plurality of devices, the information server 200 may send different information related to media and/or metadata received from the plurality of devices. As an example, when the presentation data received from the plurality of devices indicates that certain information generates more requests for more content related to the certain information, then the information server 200 may send the certain information more often as compared to other information that the information server 200 could send. As such, the information sent by information server 200 may be based on any one or combination of the media, metadata, and presentation data.

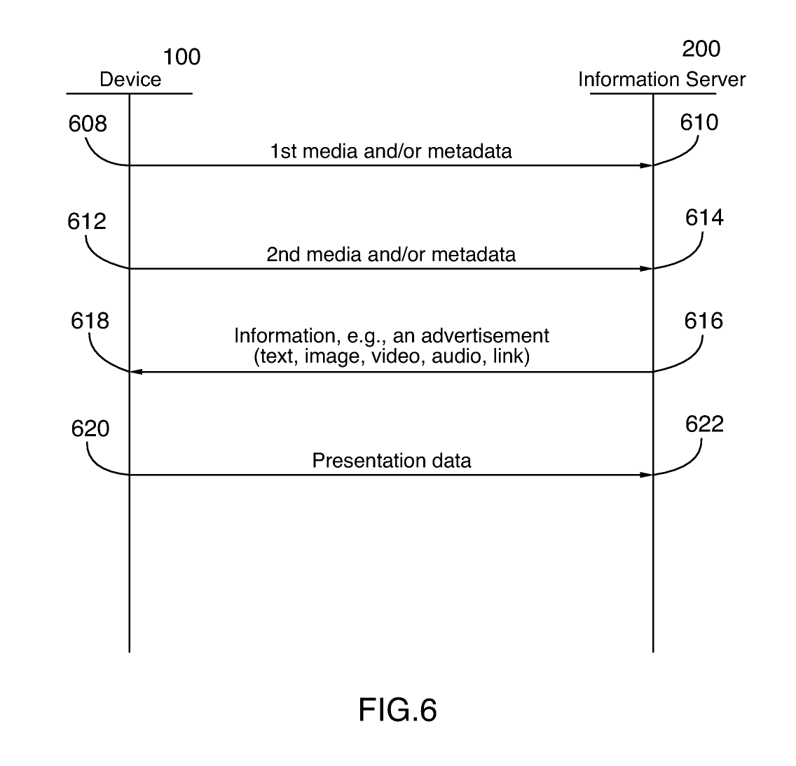

FIG. 6 is a data flow diagram illustrating information, such as an advertisement or ad, sent from the information server 200 to the wireless portable communication device 100, wherein the information sent is related to a plurality of media captured or stored by the wireless portable communication device 100. By relating the information to the plurality of media, the information has a higher likelihood of being relevant, pertinent, and appropriate to the wireless portable communication device 100.

The wireless portable communication device 100 sends at least one of a first media and a first metadata at 608 and the information server 200 receives the first media and/or first metadata at 610. The media and/or metadata may be sent in response to the capturing of the media by the wireless portable communication device 100. For example, when the wireless portable communication device 100 is a camera phone, the wireless portable communication device 100 may send the media and/or metadata after each picture taken by the camera is stored. Alternative embodiments may consolidate a plurality of media and/or metadata that is to be sent into one message. For example, a wireless portable communication device 100 may consolidate a plurality of media and/or metadata over a fixed period of time, e.g., 24 hours, and send the plurality of media and/or metadata at a fixed time to the information server 200, e.g., during off-peak hours so as to reduce data transfer charges.

The wireless portable communication device 100 sends at least one of the second media and the second metadata at 612 and the information server 200 receives the second media and/or second metadata at 614. Embodiments may have the wireless portable communication device 100 only sending media, only sending metadata, or any combination of media and metadata. As such, there may be three options for the first set of media and/or metadata sent, including: only media, only metadata, and a combination of media and metadata. There may also be four options for the second set of media and/or metadata, including: no media and no metadata, only media, only metadata, and a combination of media and metadata. Hence, there may be at least twelve possibilities for what media and/or metadata are sent.

Additionally, whether the wireless portable communication device 100 sends media, metadata, or both may be based on differences between current media and/or metadata and formerly sent media. In other words, when a first media and/or metadata is substantially the same as a second media and/or metadata, the device may send the first media and/or metadata but not send the second media and/or metadata. For example, when a second picture stored by the wireless portable communication device 100 is substantially similar to a first picture stored by the wireless portable communication device 100, the second picture may not be sent while the metadata related to the second picture is sent. Furthermore, when there are differences between the first and second metadata, the differences between the first and second metadata may be sent in lieu of the entire first and second metadata so as to reduce the amount of data being transmitted between the wireless portable communication device 100 and the information server 200.

The information server 200 sends information at 616 and the wireless portable communication device 100 receives the information at 618. As discussed above, the information may be in the form of any one or combination of text, images, video, audio, indicators, identifiers, links, and so forth. The information sent is based on any one or combination of the first media, second media, first metadata, second metadata, third metadata, and fourth metadata. As such, the information is related to the first media and second media and is more pertinent and/or appropriate.

The wireless portable communication device 100 sends presentation data at 620 and the information server 200 receives the presentation data at 622. The presentation data relates to the presentation of the information and may include data related to any one or combination of: what application presented the information, the duration of the presentation of the information, requests related to the information, and so forth. In one embodiment, presentation data may include that a request for more content related to the information is sent subsequent to when the information is displayed. For example, the information may be displayed as an advertisement on a webpage that when accessed generates a request for more content related to the advertisement.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

1. A method of a wireless portable communication device, the method comprising:
sending at least one of a first media and a first metadata and at least one of a second media and a second metadata to an information server; and
receiving information from the information server, the information related to the at least one of the first media and the first metadata and related to at least one of the second media and the second metadata.

2. The method of claim 1, wherein the at least one of the first media and the first metadata are sent via a first message and at least one of the second media and the second metadata are sent via a second message.

3. The method of claim 1 further comprising storing the first media.

4. The method of claim 1 further comprising, sending presentation data related to presenting the information.

5. The method of claim 4, wherein the information is related to presentation data sent to the information server from a plurality of wireless portable communication devices.

6. The method of claim 1, wherein at least part of the first metadata is based at least in part on content of the first media.

7. The method of claim 1, wherein the first metadata comprises at least one of temperature data, location data, orientation data, time data, calendar data, address book data, battery charge level data, signal strength data, network data, notification data, and social networking data.

8. A method of an information server, the method comprising:
receiving at least one of a first media and a first metadata from a wireless portable communication device and at least one of a second media and a second metadata from a wireless portable communication device;
sending information related to the at least one of the first media and the first metadata and related to the at least one of the second media and the second metadata to the wireless portable communication device.

9. The method of claim 8, wherein the at least one of the first media and the first metadata is received via a first message and the at least one of the second media and the second metadata are received via a second message.

10. The method of claim 8 further comprising:
after receiving the first media, storing a third metadata related to the first media;
after receiving the second media, storing a fourth metadata related to the second media.

11. The method of claim 10, wherein the information is related to the third metadata and related to the fourth metadata.

12. The method of claim 10, wherein at least part of the third metadata is based at least in part on content of the first media.

13. The method of claim 8 further comprising, receiving presentation data related to presenting the information from a plurality of wireless portable communication devices.

14. The method of claim 13, wherein the information is related to the presentation data.

15. The method of claim 8, wherein the first metadata comprises at least one of temperature data, location data, orientation data, time data, calendar data, address book data, battery charge level data, signal strength data, network data, notification data, and social networking data.

16. An apparatus comprising:
a storage;
a communication subsystem; and
at least one processor configured to:
store to the storage a first metadata related to a first media
store to the storage a second metadata related to a second media;
send to an information server at least one of the first media and the first metadata and at least one of the second media and the second metadata via the communication subsystem; and
receive information from the information server via the communication subsystem, the information related to the at least one of the first media and the first metadata and related to at least one of the second media and the second metadata.

17. The apparatus of claim 16, wherein the at least one of the first media and the first metadata are sent in a first message and at least one of the second media and the second metadata are sent via a second message.

18. The apparatus of claim 16, wherein the one or more processors are further configured to send, via the communication subsystem, presentation data related to presenting the information.

19. The apparatus of claim 18, wherein the information is related to presentation data sent to the information server from a plurality of wireless portable communication devices.

20. The apparatus of claim 16, wherein at least part of the first metadata is based at least in part on content of the first media.

21. The apparatus of claim 16, wherein the first metadata comprises at least one of temperature data, location data, orientation data, time data, calendar data, address book data, battery charge level data, signal strength data, network data, notification data, and social networking data.

22. An apparatus comprising:
a communication subsystem; and
at least one processor configured to:
receive from at least one wireless portable communication device at least one of a first media and a first metadata and at least one of a second media and a second metadata via the communication subsystem; and
send information to the wireless portable communication device via the communication subsystem, the information related to the at least one of the first media and the first metadata and related to at least one of the second media and the second metadata.

23. The apparatus of claim 22, wherein the at least one of the first media and the first metadata is received via a first message and the at least one of the second media and the second metadata are received via a second message.

24. The apparatus of claim 22, further comprising a storage, wherein the at least one processor is further configured to:
store a third metadata related to the first media after receiving the first media;
store a fourth metadata related to the second media after receiving the second media.

25. The method of claim 24, wherein the information is related to the third metadata and related to the fourth metadata.

26. The method of claim 24, wherein at least part of the third metadata is based at least in part on content of the first media.

27. The method of claim 22, wherein the at least one processor is further configured to receive presentation data related to presenting the information from a plurality of wireless portable communication devices.

28. The method of 27, wherein the information is related to the presentation data.

29. The method of 22, wherein the first metadata comprises at least one of temperature data, location data, orientation data, time data, calendar data, address book data, battery charge level data, signal strength data, network data, notification data, and social networking data.

30-44. (canceled)
